(19) United States
(12) Patent Application Publication
(10) Pub. No.: US 2009/0078003 A1
(43) Pub. Date: Mar. 26, 2009

(54) Free-surface mixing method and apparatus therefor

(76) Inventors: Glen Bennett Cook, Elmira, NY (US); Zagorka Dacic Gaeta, Ithaca, NY (US); Dean Michael Thelen, Addison, NY (US)

Correspondence Address: CORNING INCORPORATED, SP-TI-3-1, CORNING, NY, 14831, US

(21) Appl. No.: 11/903,630

(22) Filed: Sep. 24, 2007

(51) Int. Cl. C03B 7/092

(52) U.S. Cl. 65/126; 65/134.4; 65/157; 65/178

(57) ABSTRACT

A method of mixing a viscous liquid comprising flowing the viscous liquid through an aperture to form a stream that falls through a free space volume by gravity. The viscous liquid may be directed through any combination of apertures. The corresponding streams of viscous liquid may be allowed to undergo fluid buckling as the streams fall, with the streams spreading the inhomogeneities and then recombining with each other, thereby mixing the viscous liquid globally and locally. A jet of gas may be directed against the falling streams to intertwine the streams, thereby mixing the viscous liquid. Alternatively, the streams may be manipulated with an electromagnetic field to create intertwining.

### BACKGROUND OF THE INVENTION

1. Technical Field of the Invention

The present invention is directed to a method and apparatus for mixing viscous liquids, and particularly for mixing a glass melt without the use of rotating stirring blades.

2. Description of Related Art

In a conventional glass making process, glass precursors are mixed in appropriate proportions to form a batch material. The batch is then melted in a furnace to form a molten glass or glass melt that is flowed or delivered through a delivery system to a point where the molten glass is used in the manufacture of a final product. Unfortunately, the glass melt flowing from the melting furnace is not typically homogeneous: a variety of process conditions can be responsible for causing variations in density and chemical composition of the melt. For example, temperatures can vary or variations in batch proportions may occur. Level fluctuations may wash different levels of the furnace walls with molten glass. Pipe flow phenomena may result in different flow rates through the delivery system used to transport the melt. These and other process variations may therefore result in physical and/or chemical inhomogeneities that are both temporally and spatially dependent. These homogeneities will hereinafter be referred to as cord.

Consider a tube adapted to transport the molten glass. A cross section of the tube transverse to the longitudinal axis of the pipe will reveal a cross section of the molten glass. At any instant in time, the chemical composition of that cross section may vary spatially—the chemical composition of the melt over the cross sectional area is not uniform at that instant. Thus, spatial inhomogeneity exists. Moreover, that spatial distribution itself may also vary over time, thus creating a temporally dependent inhomogeneity. As used herein the temporal inhomogeneity may be viewed as the time dependent spatial variation. That is, how the cross sectional inhomogeneity varies as a function of time.

The aforementioned compositional variations may exhibit a variety of time constants. For example, temporal variations (e.g. cross sectional chemical inhomogeneity as a function of time) may occur quite rapidly, on the order of minutes, to quite slowly—on the order of hours or days.

Chemical inhomogeneities may result in variations of refractive index within the molten glass, or melt, that in some applications produce undesirable optical anomalies in the finished glass product, such as in an optical display.

To mitigate these chemical inhomogeneities, or cord, the melt must be conditioned, typically by actively stirring to mix and homogenize the melt. Stirring is most generally accomplished by flowing the melt through a stirring vessel in which one or more stirrers are rotated through the melt. The stirrers may include paddles or vanes that stretch, cut and fold the glass as the stirrer rotates, reducing the cord to dimensions small enough that they are of less concern, though not completely eliminated. However, fabrication of devices comprising moving parts in a very high temperature environment can prove challenging.

Because the glass is relatively viscous, as compared to say, liquid water, and the stirrer blades extend close to the walls of the stir chamber, significant shear stress is developed at the surfaces of the stirring vessel and the stirrer(s). Moreover, the molten glass is chemically aggressive in its molten state, particularly at the high temperatures used to process the material (typically in excess of 1400° C.). Although chemically stable, high temperature refractory metals are often used in the construction of the stirring vessel and the stirrers, e.g. platinum-rhodium alloys, the high temperature and corrosive nature of the molten glass, coupled with the high shear stress, can result in erosion of the metal and the subsequent release of metallic particulate (inclusions) into the melt that may render the finished glass article unusable. Thus, while the use of active stirring processes are reasonably effective at reducing cord, they may produce undesirable side effects—the release of metallic particulate which is accompanied by its own set of problems when present in the final product.

U.S. Pat. No. 2,577,213 to G. Slayer, et al. describes a method and apparatus for mixing glass that uses a vertical free falling stream of molten glass that is reoriented to a horizontal plane by catching the stream on a moving platform/container. That is, the stream falls into a receiving container that is reciprocated to lap the stream within receiving container. While capable of mixing the molten glass, the method relies on moving components and mechanically forced reorientation of the molten glass. Thus, interaction between high temperature surfaces (e.g. bearing surfaces) may become issues over extended periods of operation.

### BRIEF SUMMARY OF THE INVENTION

The present invention provides a method and an apparatus for mixing a viscous liquid. The present invention may be used on a variety of viscous liquids, but is well suited for the mixing and homogenizing of a glass melt (i.e. molten glass) and eliminates the rotating members and incumbent high shear stress typically found in conventional glass stirring operations.

In one embodiment, a method of mixing a glass melt is disclosed comprising flowing the glass melt having a viscosity μ through an aperture defined by a first surface as a first stream, the first stream falling a distance d through a first free space volume to a second surface that is stationary with respect to the first surface, and wherein d and μ are selected to produce fluid coiling of the stream at the second surface that mixes the glass melt.

In another embodiment, a method of mixing a glass melt is described comprising a) flowing the glass melt having a viscosity μ through a first aperture defined by a first surface, the glass melt falling a distance d₁ as a first stream through a first free-space volume to a second surface stationary with respect to the first surface; b) after the flowing of step a), flowing the glass melt through a second aperture defined by the second surface, the glass melt falling a distance d₂ as a second stream through a second free-space volume to a third surface stationary with respect to the second surface, and wherein d1, d₂ and μ are selected to produce fluid coiling of the first and second streams at the second and third surfaces, respectively, that mixes the glass melt.

In still another embodiment a method of mixing a molten glass is described comprising dividing the molten glass into at least one molten glass stream that falls through a first free space volume, the molten glass stream undergoing viscous buckling that mixes the glass melt.

In yet another embodiment, an apparatus for mixing molten glass is presented comprising a first surface defining a first aperture through which a glass melt having a viscosity μ is flowed to produce a first stream that falls through a first free space volume, a second surface disposed a distance d below and stationary with the first surface, the second surface defining a plurality of apertures through which the molten glass is flowed as a plurality of streams that fall through a second free space volume, and wherein d is selected to result in fluid buckling of the first stream at the second surface for the viscosity μ.

It is to be understood that both the foregoing general description and the following detailed description are merely exemplary of the invention, and are intended to provide an overview or framework for understanding the nature and character of the invention as it is claimed.

The accompanying drawings are included to provide a further understanding of the invention, and are incorporated in and constitute a part of this specification. The drawings are not necessarily to scale, and sizes of various elements may be distorted for clarity. The drawings illustrate one or more embodiment(s) of the invention, and together with the description serve to explain the principles and operation of the invention.

### BRIEF DESCRIPTION OF THE DRAWINGS

FIG. 1 is a cross sectional side view of an apparatus for mixing a viscous liquid in accordance with an embodiment of the present invention.

FIG. 2 is a cross sectional side view of an apparatus for mixing a viscous liquid in accordance with another embodiment of the present invention wherein the viscous liquid flows onto a surface defining an aperture.

FIG. 3 is a cross sectional view of an apparatus according to another embodiment comprising an aperture plate defining a plurality of apertures.

FIG. 4 is a cross sectional view of an apparatus for mixing viscous liquids according to another embodiment of the present invention comprising a plurality of aperture plates, including an aperture plate defining a single aperture and an aperture plate defining a plurality of apertures.

FIG. 5 is a cross sectional view of an apparatus for mixing viscous liquids according to another embodiment of the present invention comprising a plurality of aperture plates, each of the plurality of aperture plates defining a plurality of apertures.

FIG. 6 is a photograph of an apparatus for mixing viscous liquids according to another embodiment of the present invention comprising a plurality of aperture plates, each of the plurality of aperture plates defining a plurality of apertures.

FIG. 7 is a cross sectional view of an apparatus for mixing a viscous liquid that employs a gas jet directed onto the viscous liquid streams issuing from the aperture plate.

FIG. 8 is a cross sectional view of an apparatus for mixing viscous liquids that charges the streams of molten glass, then deflects the streams with an electromagnetic field.

FIG. 9 is a cross sectional view of another apparatus for mixing molten glass comprising deflectors disposed in the vessel's lower portion for intersecting streams of molten glass issuing from the aperture plate.

FIG. 10 is a top down cross sectional view through the lower portion of a vessel for mixing viscous liquids according to an embodiment of FIG. 9 showing an exemplary orientation of bars for intercepting and redirecting the streams of viscous liquid.

### DETAILED DESCRIPTION

The present invention provides a method and apparatus for mixing a viscous liquid without the incumbent shearing stress typically found in processes using rotating mechanical stirrers. For example, in a glass making process, shearing stresses resulting from active stirring of molten glass in a platinum mixer can be responsible for introducing undesirable erosion products (e.g. platinum) into the glass. The present invention develops the viscous liquid into a free-surface stream that stretches and folds into itself. The present invention is useful for mixing all manner of viscous liquids, and in particular, molten glass.

Shown in FIG. 1 is an apparatus 10 according to an embodiment of the present invention for mixing a viscous liquid comprising aperture 12 through which viscous liquid 14 flows and falls as stream 16 a distance d through free space volume 18 under the influence of gravity before contacting surface 20. Preferably, a viscosity of the viscous liquid is equal to or less than about 5000 poise. Preferably, free space volume 18 is heated to maintain the viscosity of the viscous liquid. As the stream descends, it stretches and thins under the influence of gravity, surface tension and internal viscous drag, and upon contact with surface 20 begins to buckle, first on surface 20, and then on itself. A pool of viscous liquid accumulates and the buckling stream of viscous liquid is incorporated into the pool, thereby mixing the viscous liquid.

Aperture 12 may be any shape, but is preferably generally circular in cross section. However, aperture 12 may be in the form of a slot, in which case folding rather than coiling occurs. A circular aperture, for example, yields a generally cylindrical stream of viscous liquid flowing from the aperture, whereas a slot yields a flattened stream of viscous liquid (i.e. a sheet). As shown, aperture 12 may be defined by a tube or pipe, or a plurality of tubes or pipes, in fluid communication with a supply of viscous liquid (not shown). By free space volume what is meant is that the volume comprises a region free of liquid through which the stream may fall. Naturally, the stream, by extension, comprises a free surface—a surface that is exposed to the free space volume. The free space volume may comprise a gas or gases, or the free space volume may be a vacuum.

Advantageously, stream 16 buckles without the need to artificially (e.g. mechanically) translate the stream (or the surface that the stream contacts). That is, the stream buckles according to the physical phenomenon described below, thereby eliminating the need for moving parts within apparatus 10. This is particularly beneficial when mixing high temperature viscous liquids, such as molten glass having a temperature in excess of about 1400° C.

As used herein, fluid buckling is a phenomenon that may occur when a free-falling viscous fluid (i.e. liquid) encounters a surface (e.g. a horizontal plate or floor for example). That is, a viscous liquid issuing from, for example, an aperture, and falling a sufficient distance through a free-space region and then contacting a surface may exhibit any one or more of a variety of steady state or chaotic motions at the surface, including, for example, snaking (generally horizontal “S” shapes), coiling (generally circular shapes), lapping (generally vertical “S” shapes) and combinations thereof. For the sake of simplifying discussion, and not limitation, the present description will be directed to the coiling behavior of a stream of viscous liquid having a generally circular transverse cross section. As used herein, such coiling may be referred to as liquid rope coiling, or fluid coiling whereas a more general term that includes lapping or folding may be referred to as fluid buckling.

In an exemplary illustration of fluid coiling for example, a fluid (i.e. liquid) having a density ρ, a viscosity μ (kinematic viscosity υ=μ/ρ), a characteristic stream radius a₁, falls through a height d under the influence of gravity g at a volumetric flow rate Q. If d is sufficiently large, the stream becomes unstable due to pertubating forces (e.g. gravity and viscous resistance to bending of the stream) and may form a regular coil having a substantially constant diameter on a surface beneath the stream characterized by a coil having a radius R at a frequency Ω. The coiling frequency Ω is strongly dependent on the height d through which the stream falls. Indeed, Neil M. Ribe provides a more detailed description of fluid coiling in “Coiling of Viscous Jets”, Proceedings of the Royal Society, v.460 (2004), pp. 3223-3239, the content of which is incorporated herein by reference. Ribe identifies multiple height-dependent fluid coiling regimes: viscous coiling, gravitational coiling and inertial coiling. Viscous coiling occurs when the radius of the coil is approximately equal to the height d through which the stream falls. The coiling frequency Ω in the viscous coiling regime can be approximated by the equation Ωᵥ=a₁⁻²Qd⁻¹. In the viscous coiling regime, the diameter of the stream does not change appreciably as the stream falls through the free space volume, coil, and the rotational period of the resultant coil. The coiling is dependent upon, inter alia, the gravitational force, the flow rate of the viscous fluid, the diameter of the aperture, the drop or free-fall distance and the density, viscosity and surface tension of the fluid. The coiling occurs when the falling filament becomes unstable in the face of bending disturbances. This instability appears when the fluid Reynolds number falls below a critical value. Viscous buckling is described in more detail by Habibi, et al. in “Dynamics of Liquid Rope Coiling”, Physical Review E74 (66306), The American Physical Society (2006), pp. 1-10, and by Neil M. Ribe in Physical Review E68 (036305), The American Physical Society (2003), pp. 1-10 the contents of which are incorporated herein by reference in their entirety.

During gravitational coiling, the stream thins/tapers as it falls, and the resulting coil occupies only a small fraction of the total height d. The gravitational coil radius can be approximated as g^{-1/4}(υQ)^{1/4} and the coiling frequency in the gravitational coiling regime Ω_{G} is approximated by g^{1/4}υ^{1/4}a₁^{4/3}Q^{3/4}. Finally, during inertial coiling, the coiling radius can be represented by υ^{1/3}a₁^{4/3}Q^{-1/3}, and the frequency of coiling in the inertial regime Ω_{G} is approximated by υ^{-1/3}a₁^{-10/3}Q^{4/3}.

As used herein, fluid coiling will be interpreted to denote the spontaneous coiling of a viscous fluid stream when contacting a surface below the stream, including the regimes described above.

Returning to FIG. 1, consider that viscous liquid 14 is a physically or chemically inhomogeneous liquid. For example, local variations in refractive index of a finished glass product may stem from chemical inhomogeneities in the preceding glass melt (molten glass) wherein the glass melt contains cord. As viscous liquid 14 flows through aperture 12, and falls a distance d through free-space volume 18 the resulting stream 16 stretches and thins. The viscous liquid, and the inhomogeneity it contains, varies vertically after exiting aperture 12. As attenuated stream 16 contacts surface 20, the stream forms coil 22 and the orientation of the inhomogeneity (e.g. cord is a glass melt) is changed to a substantially horizontal orientation. Moreover, because of the coiling, the horizontal orientation includes an angular or rotational component. It should be pointed out that unlike certain prior art examples of mixing viscous liquids by flowing the viscous liquid through a free space volume, there is no need for moving parts in accordance with the present embodiment. Moreover, the buckling at the surface to which the viscous liquid falls does not occur as a result of bending forces applied by any apparatus. That is, the vertical position of the stream, or streams, remains substantially stationary, and the surface to which they fall does not translate (is stationary).

As an example of the foregoing, assume the inhomogeneity is a variation in concentration of a single constituent of a multiconstituent viscous liquid. As the viscous liquid stream descends from aperture 12, the concentration varies vertically along the length of the falling liquid. However, as the viscous liquid begins to coil, the concentration variation is oriented horizontally. Moreover, the horizontal orientation varies rotationally due to the circular nature of the coil. Over time, the coil may slump, and/or topple, further distributing the chemical concentration variation. Thus, the inhomogeneous viscous liquid is mixed and made more homogeneous by a reorientation of the liquid.

Of course, the concentration variation above was used as a simple illustration. Other inhomogeneities in a viscous liquid may be considered, and the mixing thereof (making more homogeneous), are contemplated by the present invention, including temperature variations, density variations, chemical/composition variations, particulate dispersion variations, etc.

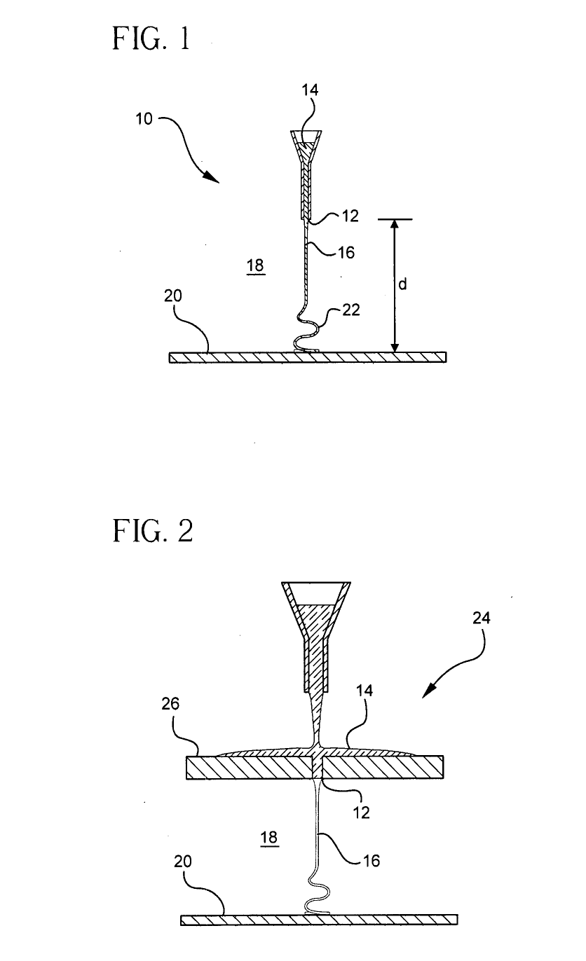

In another embodiment depicted in FIG. 2, an apparatus 24 is depicted comprising surface 26 defining at least one aperture 12. Viscous liquid 14 flows onto surface 26 and through aperture 12. In some embodiments it is desirable to allow viscous liquid 14 to pool over aperture 12. If viscous liquid 14 is not allowed to pool, the flowing liquid may draw in any atmosphere above surface 26, and stream 16 may be in the form of a hollow tube. Consequently, if viscous liquid in the particular process in which the present invention is employed is intended to be free of gaseous inclusions, it may be undesirable to run the process without a pool of viscous liquid above surface 26.

For high temperature viscous liquids such as a glass melt, surface 26 is preferably in the form of a plate formed from a refractory material capable of withstanding the high temperature and aggressive chemical nature of the molten glass. Surface 26 will hereinafter be referred to as aperture plate 26. However, it should be apparent that surface 26 need not be in the form of a plate, i.e. planar. Indeed, as shown in FIGS. 1-2, aperture 12 may be the aperture in a pipe or tube.

Aperture plate 26 may, for example, be comprised of a refractory metal selected from the platinum group, i.e. platinum, iridium, palladium, rhodium, osmium, ruthenium or combinations thereof. In other embodiments, aperture plate 26 may be comprised of a ceramic refractory material. For low temperature and/or less chemically aggressive viscous liquids, other materials may be substituted for refractory materials. For example, steel, stainless steel or even plastics may be appropriate. That is to say, the choice of material(s) for the aperture-defining surface depends, inter alia, upon the materials being mixed.

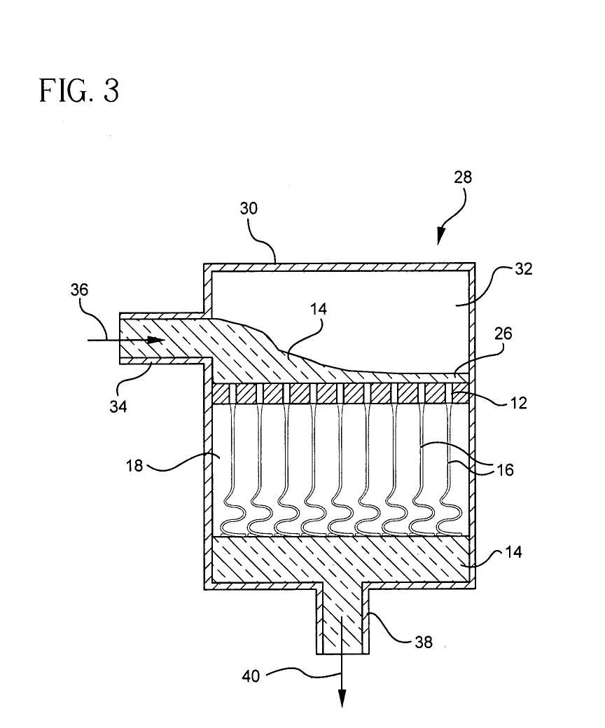

In another embodiment shown in FIG. 3, an apparatus 28 is shown comprising aperture plate 26 defining a plurality of apertures 12, thus dividing viscous liquid 14 into a plurality of streams 16 that fall through free-space volume 18 onto the surface of a pool of the viscous liquid 14. Each stream 16 undergoes fluid buckling, and, if the streams are substantially circular in cross section, fluid coiling. Each stream 16 of the plurality of streams distributes and mixes a localized portion of the liquid. As used hereinafter, mixing that occurs as a result of flow through a single aperture will be referred to as global mixing, whereas mixing that occurs as a result of flow through a plurality of apertures will be referred to as local or localized mixing.

Aperture plate 26 is contained within vessel 30 and divides the interior of vessel 30 into a volume 32 above aperture plate 26 and free space volume 18 below aperture plate 26. Viscous liquid 14 is supplied to volume 32 through inlet 34 as indicated by arrow 36 and flows through the plurality of apertures 12 in aperture plate 26 in an example of local mixing. The viscous liquid that accumulates or pools at the bottom of vessel 30 then exits vessel 30 through outlet 36 as indicated by arrow 38.

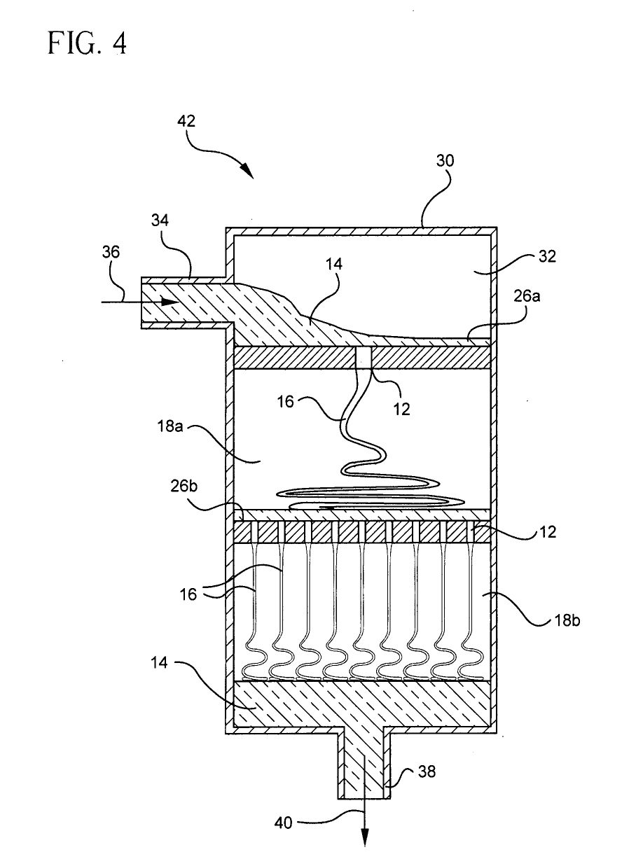

It should be apparent to one skilled in the art having had the benefit of the present disclosure that global (single aperture) and localized ( plural aperture) mixing subunits may be combined into various combinations to effect different mixing efficiencies for liquids of different natures and viscosities. For example, in the embodiment illustrated in FIG. 4, an apparatus 42 is shown wherein viscous liquid 14 is flowed into first volume 32 and onto aperture plate 26a defining a single aperture 12. The viscous liquid flows through the single aperture 12 and forms a stream 16 in free space volume 18a that undergoes fluid buckling onto a second aperture plate 26b defining a plurality of apertures 12. The viscous liquid that accumulates on second aperture plate 26b flows through the plurality of apertures 12 to form a plurality of free surface streams 16 that undergo fluid buckling and accumulate at the bottom of vessel 30. In accordance with the previously adopted terminology, the configuration of the present embodiment is a global-local mixing configuration. Of course any number of aperture plates may be used as is necessary to accomplish the desired level of mixing. Preferably, the apertures on one aperture plate are not vertically aligned with the apertures of a next following, or preceding, aperture plate. The distance between aperture surfaces (e.g. aperture plates) through which each stream falls may be selected based on the viscosity of the glass melt. Preferably, the glass melt is heated to maintain a constant viscosity by suitable heating of vessel 3

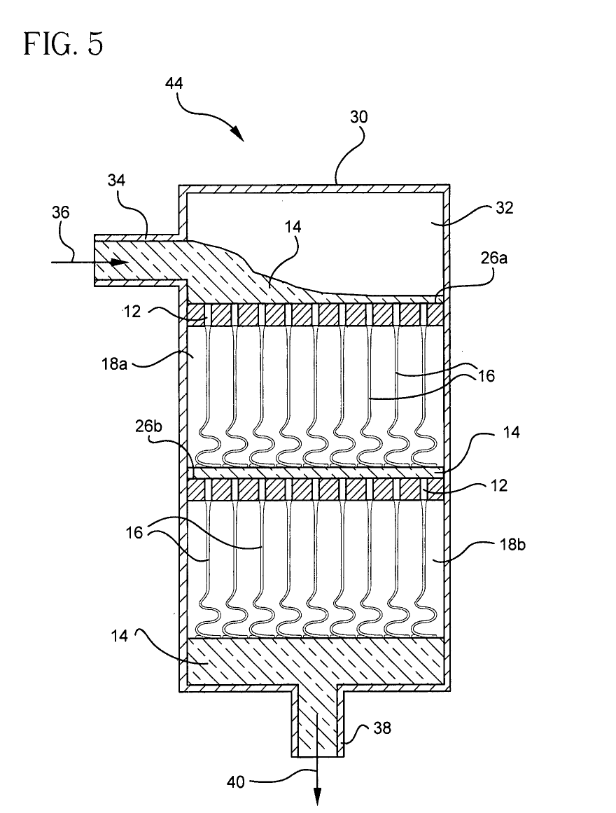

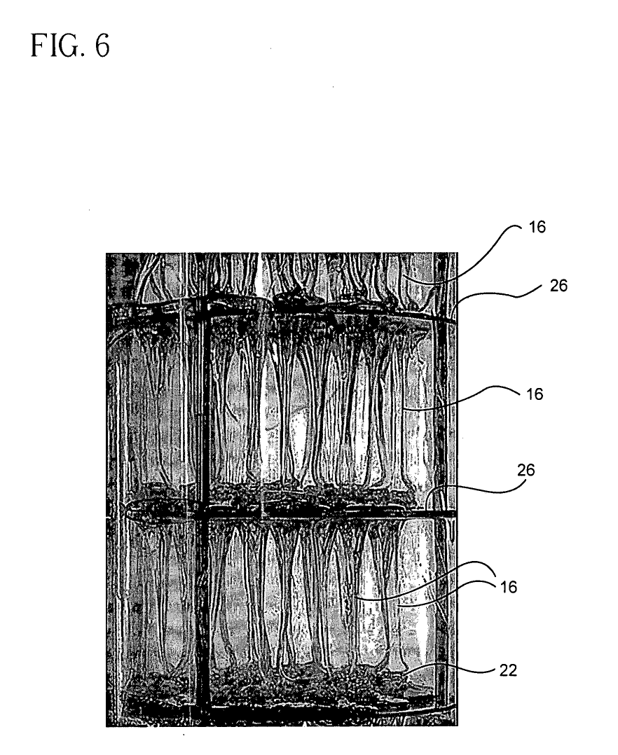

FIG. 5 shows an apparatus 44 substantially the same as apparatus 42 with the exception that uppermost aperture plate 26a defines a plurality of apertures 12. Thus, apparatus 44 depicts a local—local mixing configuration. FIG. 6 is a photograph of an experimental setup illustrating flow of viscous oil through several aperture plates contained within a clear vessel similar to FIG. 5. Fluid buckling in the form of fluid coiling can be observed below each aperture plate. Aperture plates, viscous liquid streams and coils have been referred to simply as reference numerals 26, 16 and 22 in the figure.

Any combination of aperture plate configurations may be employed, depending on the nature of the particular viscous liquid or liquids to be mixed, and the desired level of mixing. Other configurations include, but are not limited to, global-local, local-global, global-global, local-local, and so forth, and for as many iterations as desired.

In some embodiments, the free space volume through which the viscous liquid falls may be evacuated, or the free space volume may contain, for example, a rapidly diffusing, preferably inert gas such as helium. Any voids that may become entrained in the viscous liquid then either collapses, or gas contained in the void rapidly diffuses from the liquid. Voids may become entrained in the viscous liquid, for example, by operating under conditions such that a pool of viscous liquid does not form over an aperture plate, causing a tubing effect as the viscous liquid flows through the aperture and pulling the “atmosphere” above the aperture plate into the center of the flow (even if an atmosphere contained in the volume is a vacuum). Alternatively, voids may become entrained in the viscous liquid if, when coiling onto a surface below the aperture plate the coil builds to a sufficient height that it fall over, thus trapping the surrounding “atmosphere within the collapsed coil. If lapping occurs, the lap may fold over in such a way that the atmosphere is trapped within the folds, thus entraining the atmosphere.

The entraining behaviors described above, while seemingly undesirable, may, in some embodiments, be advantageous. For example, in a typical glass making process, constituent glass forming materials (batch materials) are melted to form a molten glass precursor material, or glass melt. The melting process produces gaseous by-products that for some glass products are undesirable and therefore must be removed. This can be done, for example, by including a fining agent among the batch materials. The fining agent is chosen so as to release a gas (or gases), typically oxygen, into the melt thus forming large bubbles in the melt. Gases resulting from the melting process coalesce into the large bubbles released by the fining agent. In effect, the fining agent gas collects and lends buoyancy to the melting gases, so that the combined bubbles rise to the surface of the melt and can be released. Such fining may, for example, take place is a special vessel wherein the temperature of the glass melt is increased to reduce the viscosity of the melt and make it easier for the bubbles to rise to the surface.

In one embodiment, a free-surface mixing apparatus according to the present invention may be inserted into the flow of a glass melt prior to the melt entering the fining vessel, and operating so as to entrain a specific fining gas into the molten glass to enhance the fining process.

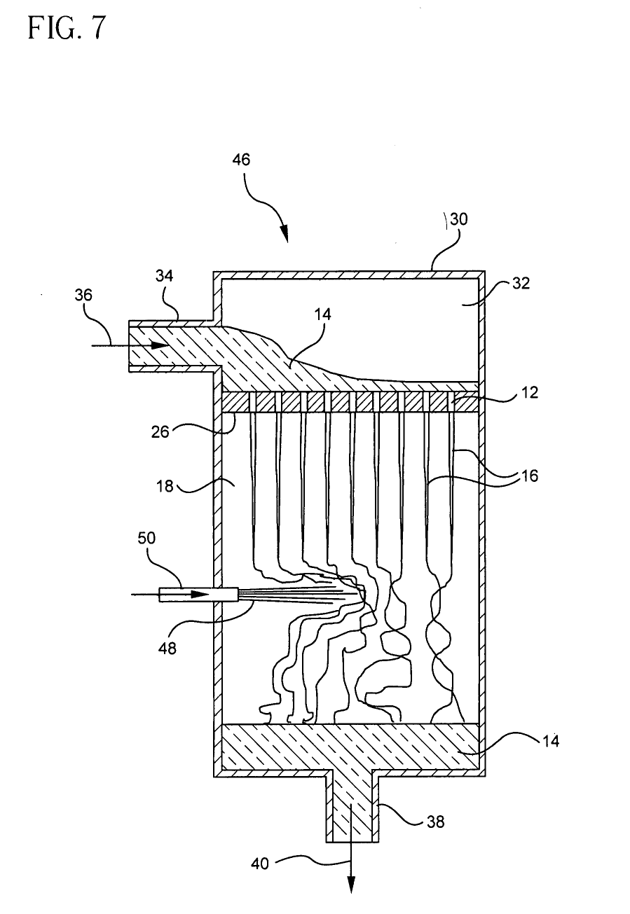

In still another embodiment of the present invention, a forced gas jet may be used to create turbulence in the free space volume through which the glass exiting the aperture plate descends. Accordingly, as illustrated in FIG. 7, an apparatus 46 is shown comprising mixing vessel 30 having inlet 34 and outlet 38 and further comprising aperture plate 26 defining a plurality of apertures 12 that separates mixing vessel 30 into an upper portion 32 and a lower free space portion 18. Viscous liquid 14 entering the upper portion 32 of mixing vessel 30 through inlet 34 as indicated by arrow 36 flows through apertures 12 as streams 16 that descend through free space portion 18 of mixing vessel 30. During the descent, a gas jet 48 is directed through nozzle 50 at viscous liquid streams 16 in a direction generally orthogonal to the streams, creating turbulence in free space volume 18 that intertwines and mixes the streams. As previously described, the descent of the viscous liquid streams causes the streams to attenuation, thereby stretching inhomogeneities within the streams. The turbulence created by the gas jet mixes the viscous liquid, after which the liquid is assimilated into the pool of viscous liquid 14 at the bottom of mixing vessel 30 before exiting vessel 30 through outlet 38, as indicated by arrow 40. The gas issuing from gas nozzle 50 may be heated if necessary, depending on the temperature and nature of the viscous liquid. For example, if the viscous liquid is a glass melt, it is preferable to heat the air prior to passing the air through nozzle 50.

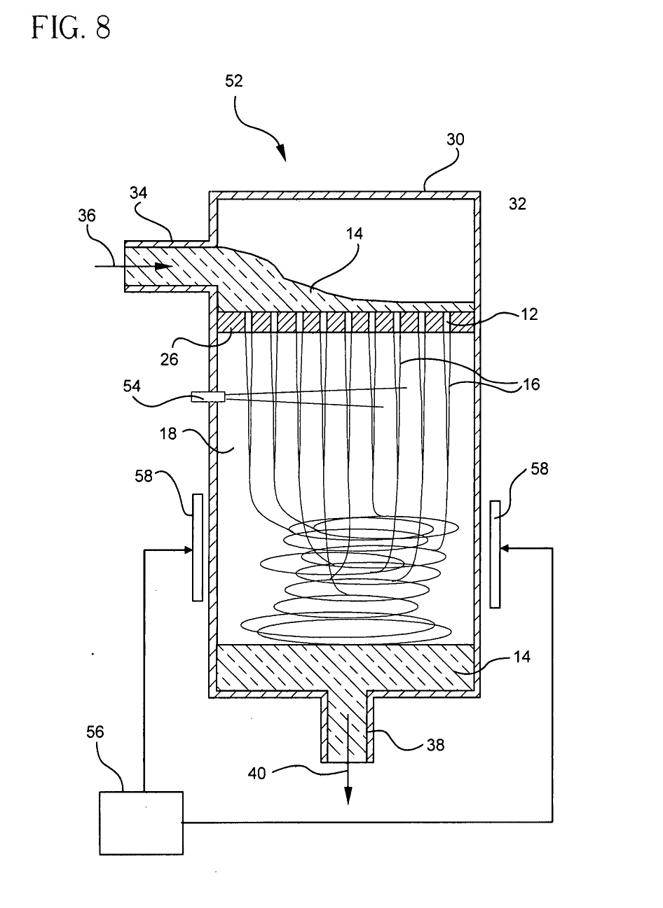

In still another embodiment illustrated in FIG. 8, an apparatus 52 is shown comprising vessel 30 having an inlet 34, an outlet 38 and comprising an aperture plate 26 defining a plurality of apertures 12 that separate the vessel into a first, upper portion 32 and a second, lower free space portion 18. Viscous liquid 14 flows into upper portion 32 through inlet 34, as indicated by arrow 36 and then flows through apertures 12 as viscous liquid streams 16. Vessel lower portion 18 is evacuated, and the viscous liquid streams 16 issuing from apertures 12 are deflected by a dynamic electromagnetic field, such as a radio frequency (rf) field. As shown in FIG. 8, a charge may be introduced to the viscous liquid streams, such as with ion plasma gun 54, and then the electromagnetic field generated by rf generator 56 and emitters 58 may be used to cause glass streams 16 to align themselves relative to the electromagnetic field. By dynamic electromagnetic field, what is meant is a field that is modulated. For example, the intensity if the field may be modulated. The field may also be spatially modulated by causing the field to move. Movement of the field may be undertaken for example, by rotating the field. The dynamic field may then be used to cause the streams to deflect and intertwine, thereby mixing the viscous liquid. The viscous liquid streams are eventually assimilated into the pool of viscous liquid 14 at the bottom of mixing vessel 30 before exiting vessel 30 through outlet 38 as indicated by arrow 40.

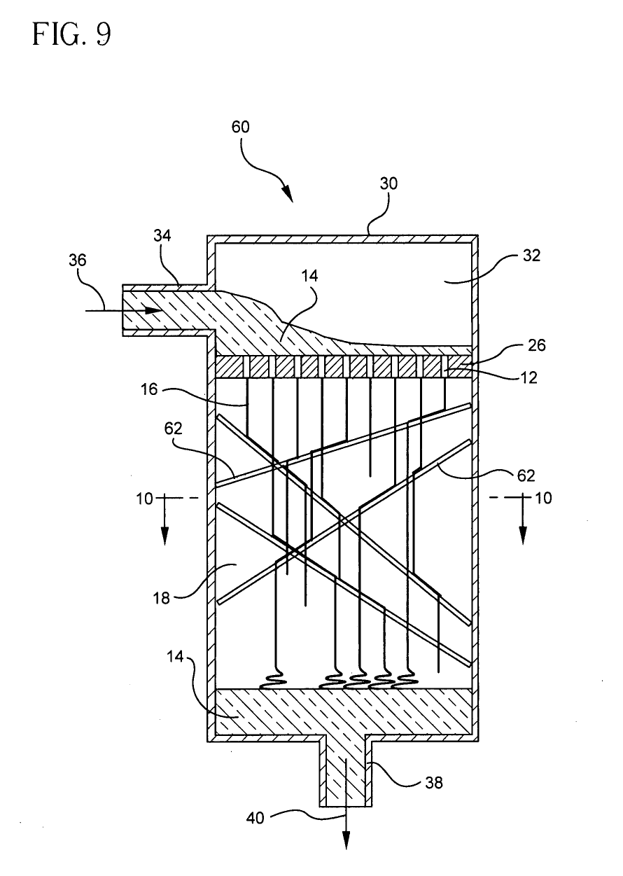

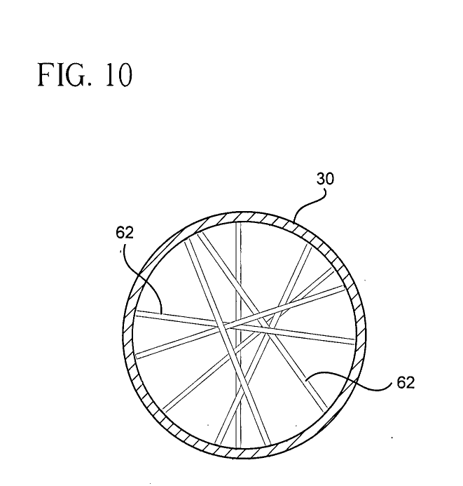

In yet another embodiment a series of bars or rods may be disposed in a vessel for intercepting and deflecting streams of viscous liquid. Shown in FIG. 9 is an apparatus 60 comprising vessel 30 having inlet 34 and an outlet 38 and comprising an aperture plate 26 defining a plurality of apertures 12 that separates vessel 30 into a first, upper portion 32 and a second, lower free space portion 18. Viscous liquid 14 flowed into upper portion 32 through inlet 34 (as indicated by arrow 36) flows through apertures 12 and forms streams 16 of viscous liquid that fall through the free space volume of lower portion 18. Deflectors 62 disposed within lower portion 18 intercept the falling streams 16 of viscous liquid, causing the streams to change direction and intersect with other falling streams of viscous liquid. Mixing also occurs as the viscous liquid flows over the surfaces of the deflectors. Deflectors 62 may be, for example, bars or rods that are generally disposed within vessel lower portion 18 at angles relative to the direction of flow of glass streams 16. The angles of the bars need not be the same from bar to bar, and the individual bars need not be oriented in the same direction. For example, FIG. 10 shows a top down cross sectional view of lower free space volume 18 with a plurality of rods 62 in different orientations across vessel lower portion 18. Indeed, vessel lower portion may contain other sizes and shapes of baffling or obstructions designed to intercept, redirect and combine individual streams 16 of viscous liquid issuing from apertures 12, including sheets and channels. Deflectors may be used in any one or all of the free space volumes in a multi-stage mixing process. That is, deflectors may be used in one or more of a plurality of free space volumes following the flow of the viscous liquid through one or more apertures.

The falling and intersecting streams of viscous liquid eventually make their way to the pool of viscous liquid at the bottom of vessel 30, where the viscous liquid may undergo fluid buckling (e.g. fluid coiling) and then exit through outlet 38 as indicated by arrow 40. In this particular embodiment, the stream of viscous liquid does not undergo fluid buckling immediately after issuing from an aperture, but instead after leaving the surface of one or more of the deflectors 62.

While the invention has been described in conjunction with specific exemplary embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

What is claimed is:

1. A method of mixing a glass melt comprising:
flowing the glass melt having a viscosity μ through an aperture defined by a first surface as a first stream, the first stream falling a distance d through a first free space volume to a second surface that is stationary with respect to the first surface; and
wherein d and μ are selected to produce fluid coiling of the stream at the second surface that mixes the glass melt.

2. The method according to claim 1 wherein the flowing the glass melt as a first stream comprises flowing the glass melt as a first plurality of streams that undergo fluid coiling at the second surface.

3. The method according to claim 2 further comprising deflecting the first plurality of streams as the streams fall through the first free space volume.

4. The method according to claim 1 further comprising after flowing the glass melt through the first free space volume, flowing the glass melt through a second aperture defined by the second surface as a second stream, the second stream falling through a second free space volume onto a third surface, wherein the second stream falls a distance d sufficient to produce fluid coiling at the third surface that mixes the glass melt.

5. The method according to claim 4 wherein the flowing the glass melt as a second stream comprises flowing the glass melt as a second plurality of streams that undergo fluid coiling at the third surface.

6. The method according to claim 4 wherein the first and second apertures are not vertically aligned.

7. The method according to claim 4 wherein the first and second free space volumes are evacuated.

8. The method according to claim 1 wherein a viscosity μ is equal to or less than about 5000 poise.

9. A method of mixing a glass melt comprising:
a) flowing the glass melt having a viscosity μ through a first aperture defined by a first surface, the glass melt falling a distance d₁ as a first stream through a first free-space volume to a second surface stationary with respect to the first surface;
b) after the flowing of step a), flowing the glass melt through a second aperture defined by the second surface, the glass melt falling a distance d₂ as a second stream through a second free-space volume to a third surface stationary with respect to the second surface; and
wherein d₁, d₂ and μ are selected to produce fluid coiling of the first and second streams at the second and third surfaces, respectively, that mixes the glass melt.

10. The method according to claim 9 wherein the first surface defines a first plurality of apertures through which the glass melt flows as a first plurality of streams that undergo fluid buckling at the second surface.

11. The method according to claim 9 wherein the second surface defines a second plurality of apertures through which the glass melt flows as a second plurality of streams that undergo fluid buckling at the third surface.

12. The method according to claim 9 wherein the first surface defines a single aperture and the second surface defines a plurality of apertures.

13. The method according to claim 9 further comprising deflecting either of the first or second streams.

14. The method according to claim 9 wherein the viscosity ∥ is less than or equal to about 5000 poise.

15. The method according to claim 1 wherein the first and second apertures are not vertically aligned.

16. An apparatus for mixing a glass melt comprising:
a first surface defining a first aperture through which a glass melt having a viscosity μ is flowed to produce a first stream that falls through a first free space volume;
a second surface disposed a distance d below and stationary with the first surface, the second surface defining a plurality of apertures through which the molten glass is flowed as a plurality of streams that fall through a second free space volume; and
wherein d is selected to result in fluid buckling of the first stream at the second surface for the viscosity μ.

17. The apparatus according to claim 16 wherein the first aperture defined by the first surface is not vertically aligned to any one of the plurality of apertures defined by the second surface.

18. The apparatus according to claim 16 further comprising a stream deflector disposed in either of the first or second free space volumes.

19. A method of mixing a glass melt comprising:
flowing the glass melt through a free-space volume as a plurality of streams;
inducing an electric charge onto the streams;
coupling an electromagnetic field to the streams; and
modulating the electromagnetic field to mix the plurality of streams.

20. The method according to claim 19 wherein the inducing an electric charge comprises impinging ions from an ion gun onto the streams.
